(19) United States
(12) Patent Application Publication
(10) Pub. No.: US 2012/0197845 A1
(43) Pub. Date: Aug. 2, 2012

(54) APPARATUS AND METHOD FOR MANAGING A FILE IN A DISTRIBUTED STORAGE SYSTEM

(75) Inventors: Kyung-Soo Kim, Gwangju-si (KR); Jae-Beom Cheon, Suwon-si (KR); Joo-Hyun Kim, Seoul (KR); Bong-Sik Sihn, Gwangju-si (KR); Bong-Joo Jin, Chungju-si (KR); Hyoung-Choul Kim, Anyang-si (KR); Young-Gyu Kim, Seongnam-si (KR); Sun Choi, Seongnam-si (KR); Gu-Yong Lee, Seoul (KR)

(73) Assignee: PSPACE INC., Seongnam-si, Gyeonggi-do (KR)

(21) Appl. No.: 13/500,037

(22) PCT Filed: Nov. 4, 2010
(86) PCT No.: PCT/KR2010/007766

§ 371 Date: Apr. 3, 2012

(30) Foreign Application Priority Data
Nov. 6, 2009 (KR) 10-2009-0106949

(51) Int. Cl. G06F 17/30; G06F 15/16

(52) U.S. Cl. 707/662; 707/E17.01

(57) ABSTRACT

The present invention relates to an apparatus and method for managing a file in a distributed storage system. The apparatus and method for managing a file in a distributed storage system calculates a retention time of the file based on at least one of a current time, a file creation time, a file modification time and a recent file inquiry time; selects the file as an archive file if the retention time of the file is larger than a predetermined reference time; and relocates an original file and some or all of copy files of the file selected as an archive file from an active server to an archive server or from an active disk to an archive disk. If the number of inquiries on the file selected as an archive file counted in a counting period is larger than a predetermined threshold value or the file is modified or changed, the original file and some or all of the copy files of the file are restored from the archive sever to the active server or from the archive disk to the active disk

### TECHNICAL FIELD

The present invention relates to an apparatus and method for managing a file in a distributed storage system (DSS), and more specifically, to an apparatus and method for managing a file in a distributed storage system, in which switching between an active file and an archive file is automatically performed by comprehensively considering a degree of aging, the number of connections, a modification state and the like of the file in the distributed storage system.

### BACKGROUND ART

A distributed storage system or a parallel storage system is a storage system which virtualizes a plurality of storage devices as one storage device. Such a distributed storage system does not store one file in one storage device, but the file is duplicated, stored and used in a plurality of virtualized storage devices in a distributed manner.

As an existing Redundant Array of Inexpensive Devices (RAID) storage device integrates a plurality of hard disks into one storage device to construct a further larger, further faster and further stable storage device, the distributed storage system may provide functions of a further larger, further faster and further stable storage system by configuring a plurality of storage devices into one storage device.

Such a distributed storage system technique is used as a core technique in cloud computing or the like, and if the number of storage devices configuring the distributed storage system increases further more, capacity and performance of the distributed storage system are proportionally enhanced, and cost-effectiveness of the Total Cost of Owner-ship is maximized. Therefore, the distributed storage system may provide high-level performance and expandability which cannot be provided by existing storage systems.

In relation to this, FIG. 1 is a view showing the configuration of a distributed storage system according to a conventional technique.

Referring to FIG. 1, a distributed storage system generally includes a plurality of storage servers (this corresponds to one virtual storage server) 110 for duplicating and storing a file in a distributed manner, and a metadata server 120 for creating and managing metadata of the file. If at least a client 130 requests input or output of a certain file through a network or the like, the metadata server 120 provides information on the storage servers 110 in which a corresponding file will be or is stored in a distributed manner. Then, the client 130 connects to the storage servers 110 and inputs or outputs the corresponding file, and thus the service is provided. (For reference, in the present invention, the terminology ‘file’ means contents inquired or requested by the client, including a file, data, contents, a chunk or the like).

Meanwhile, in such a distributed storage system, a plurality of storage servers 110 is divided into active servers 111 and archive servers 112 in order to efficiently store files, and relatively aged files (data or contents) are stored in the archive servers 112 having a somewhat low performance, and thus limited storage media can be efficiently used.

However, since a method of managing a file according to a conventional technique divides files (data or contents) into active files and archive files simply based on age and backs up aged archive files into the archive servers 112 having relatively low performance, even the files consistently and frequently requested by clients, although an extended period of time has passed after being created, are stored in the archive servers, and thus system performance is degraded.

That is, in the conventional techniques, since archive files are selected only based on a degree of aging without considering the number of current connections, a modification state or the like of the files in the least, even the files that are consistently and frequently requested by the clients are stored in the archive servers. Furthermore, if a file is selected as an archive file and moved into an archive server, it is not automatically restored to an active file although the file is frequently inquired by the clients later, and thus overall system performance and efficiency are degraded.

### DISCLOSURE OF INVENTION

### Technical Problem

Therefore, the present invention has been made in view of the above problems, and it is an object of the present invention to provide an apparatus and method for managing a file, which is capable of efficiently managing files (data or contents) and economically managing disks in a distributed storage system.

Another object of the present invention is to provide an apparatus and method for managing a file, in which switching between an active file and an archive file is automatically performed by comprehensively considering the number of connections and a modification state, as well as a degreed of aging, in a distributed storage system.

Still another object of the present invention is to provide an apparatus and method for managing a file, in which files are periodically relocated, and if the number of inquiries on a certain file increases and exceeds a predetermined level or contents of the file is modified or changed, the file is automatically restored to an active file, thereby efficiently managing the file in a distributed storage system.

Still another object of the present invention is to provide an apparatus and method for managing a file, which is capable of efficiently implementing Information Lifecycle Management (ILM) of a Disk to Disk (D2D) level in a distributed storage system.

Still another object of the present invention is to provide a distributed storage system which efficiently uses the apparatus and method for managing a file described above.

### Technical Solution

To accomplish the above objects, according to one aspect of the present invention, there is provided a file management apparatus of a distributed storage system, the apparatus including: a retention time calculation unit for calculating a retention time of the file based on at least one of a current time, a file creation time, a file modification time and a recent file inquiry time; a file selection unit for selecting the file as an archive file if the retention time of the file is larger than a predetermined reference time; and a file management unit for relocating an original file and some or all of copy files of the file selected as an archive file from an active server to an archive server or from an active disk to an archive disk.

According to another aspect of the present invention, there is provided a distributed storage system including: a plurality of storage servers including an active server and an archive server for storing a file in a distributed manner; and a metadata server for managing metadata of the file, wherein the metadata server calculates a retention time of the file based on at least one of a current time, a file creation time, a file modification time and a recent file inquiry time, and relocates an original file and some or all of copy files of the corresponding file from the active server to the archive server if the retention time of the file is larger than a predetermined reference time.

According to still another aspect of the present invention, there is provided a distributed storage system including: at least a storage server including an active disk and an archive disk for storing a file in a distributed manner; and a metadata server for managing metadata of the file, wherein the metadata server calculates a retention time of the file based on at least one of a current time, a file creation time, a file modification time and a recent file inquiry time, and relocates an original file and some or all of copy files of the corresponding file from the active disk to the archive disk if the retention time of the file is larger than a predetermined reference time.

According to another aspect of the present invention, there is provided a file management method of a distributed storage system, the method including the steps of: calculating a retention time of the file based on at least one of a current time, a file creation time, a file modification time and a recent file inquiry time; selecting the file as an archive file if the retention time of the file is larger than a predetermined reference time; and relocating an original file and some or all of copy files of the file selected as an archive file from an active server to an archive server or from an active disk to an archive disk.

### Advantageous Effects

According to the present invention, since switching between an active file and an archive file is automatically performed by comprehensively considering the number of connections and a modification state, as well as a degreed of aging, in a distributed storage system, efficient management of files and economic management of disks are enabled, and thus system performance and efficiency are improved.

In addition, according to the present invention, if the number of inquiries on a certain file relocated to an archive server increases and exceeds a predetermined level or the file is modified or changed in a distributed storage system, the file is automatically restored to an active server, and thus an efficient backup and restoration system can be constructed.

In addition, according to the present invention, since Information Lifecycle Management (ILM) of a Disk to Disk (D2D) level is efficiently implemented in a distributed storage system, old and less useful files are moved to a disk of a low cost, and thus overall cost of the entire system is reduced.

### BRIEF DESCRIPTION OF THE DRAWINGS

FIG. 1 is a view showing the configuration of a distributed storage system according to a conventional technique.

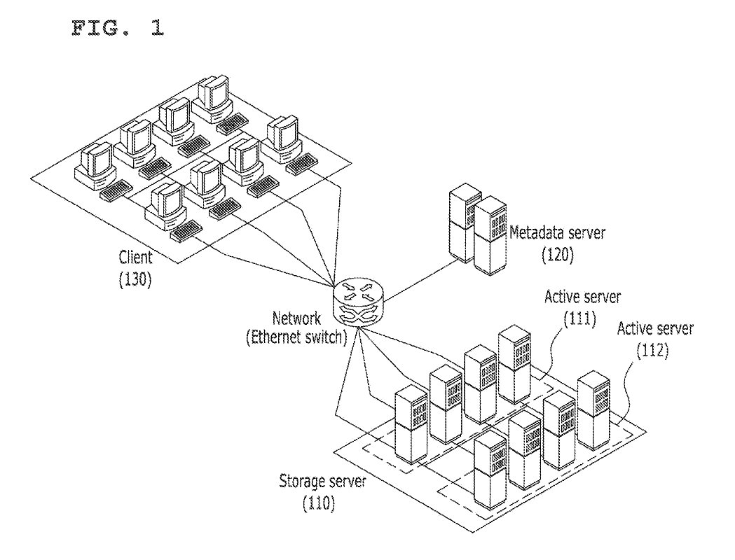

FIG. 2 is a view showing the configuration of a distributed storage system according to an embodiment of the present invention.

FIG. 3 is a view showing the configuration of a distributed storage system according to another embodiment of the present invention.

FIG. 4 is a view showing the configuration of a storage server according to an embodiment of the present invention.

FIG. 5 is a view showing the detailed configuration of a file management apparatus according to an embodiment of the present invention.

FIG. 6 is a view showing the detailed configuration of a file management apparatus according to another embodiment of the present invention.

FIG. 7 is a flowchart illustrating a file management method according to an embodiment of the present invention.

FIG. 8 is a flowchart illustrating a file management method according to another embodiment of the present invention.

FIG. 9 is a view showing an example of a method of counting the number of inquiries using a session access flag according to the present invention.

### BEST MODE FOR CARRYING OUT THE INVENTION

The preferred embodiments of the present invention will be hereafter described in detail, with reference to the accompanying drawings. Furthermore, in the drawings illustrating the embodiments of the present invention, elements having like functions will be denoted by like reference numerals and details thereon will not be repeated.

Before describing the present invention in detail, the Information Lifecycle Management (ILM) will be briefly described.

Generally, information (files, data and contents) has a lifecycle including creation, use, long-term storage, deletion and the like. The ILM manages the information according to a situation considering such an information lifecycle (i.e., considering the current stage of the information in the lifecycle). That is, the ILM efficiently manages gradually increasing data by using an optimum storage relevant to changes in the value of the information.

For example, files created just before are actively used in most cases, and tasks for modifying and inquiring the files are frequently generated. Therefore, it is preferable to broaden the bandwidth, increase the number of copy files, and store the files in a storage medium having a good performance so as to easily access the files. In comparison, the number of inquiries on aged information is decreased, and modifications on the aged information almost do not occur. Accordingly, such files do not need a broad bandwidth and are preferably stored in a storage medium having a large capacity with a relatively low performance.

In this manner, if utilization of certain information is lowered, cost of the storage system is attempted to be reduced by moving the information from an active disk to an archive disk, and such a method is referred to as a D2D backup. The present invention proposes a method of implementing a further efficient ILM at the D2D level and particularly proposes a method of efficiently managing a file comprehensively considering the number of connections and a modification state to overcome the limitations of a conventional backup method which simply considers only a degree of aging of a file.

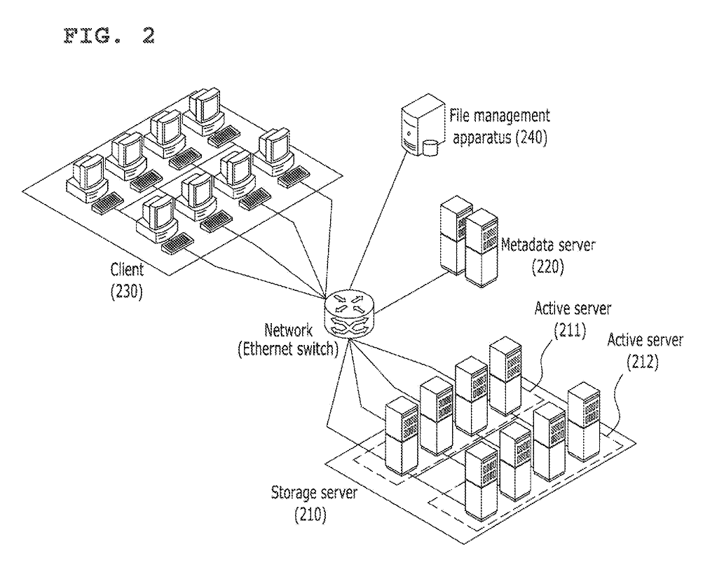

FIG. 2 is a view showing the configuration of a distributed storage system according to an embodiment of the present invention.

Referring to FIG. 2, a distributed storage system according to an embodiment of the present invention includes a plurality of storage servers 210 including an active server 211 and an archive server 212, a metadata server 220 for creating and managing metadata of the files stored in the plurality of storage servers 210, and a file management apparatus 240 for selecting and managing active files and archive files for the files. Here, it is preferable that the active server 211 is implemented in a relative high-speed storage server among the plurality of storage servers 210, and the archive server 212 is implemented in a relative low-speed high-capacity storage server among the plurality of storage servers 210. In addition, the file management apparatus 240 relocates (or backs up) the original file and some or all of copy files of a file selected as an archive file from the active server to the archive server and thus improves overall system performance through efficient file management and economic disk management.

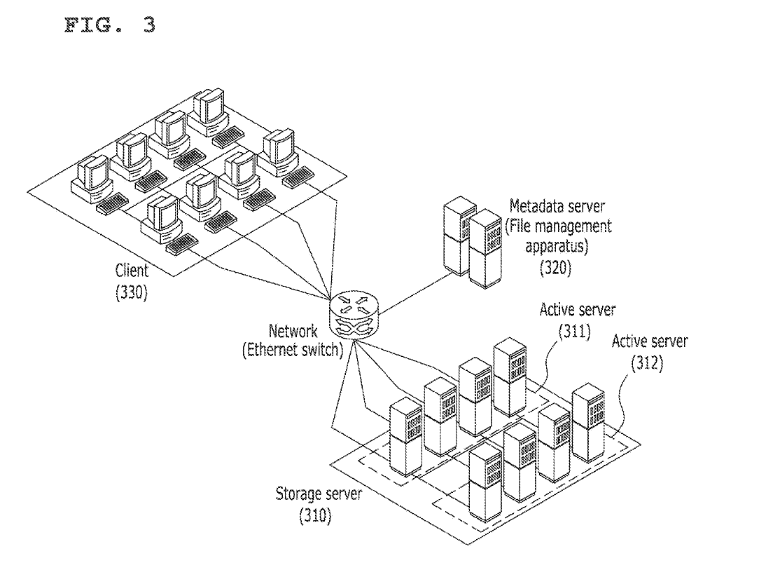

FIG. 3 is a view showing the configuration of a distributed storage system according to another embodiment of the present invention.

Referring to FIG. 3, a distributed storage system according to another embodiment of the present invention includes a plurality of storage servers 310 including an active server 311 and an archive server 312 and a metadata server 320 for creating and managing metadata of the files stored in the plurality of storage servers 310. Particularly, since the metadata server 320 includes the functions of the file management apparatus according to the present invention, the metadata server 320 relocates (or backs up) the original file and some or all of copy files of a file selected as an archive file from the active server to the archive server and thus performs efficient file management and economic disk management.

Describing additionally, the file management apparatus according to the present invention is configured as a separate apparatus or server in a distributed storage system (refer to FIG. 2) or configured as the metadata server itself or a part of the metadata server (refer to FIG. 3), backs up and stores the original file and some or all of copy files of a file selected as an archive file from the high-speed active server to the low-speed archive server, and thus improves system performance by efficiently utilizing the limited storage media.

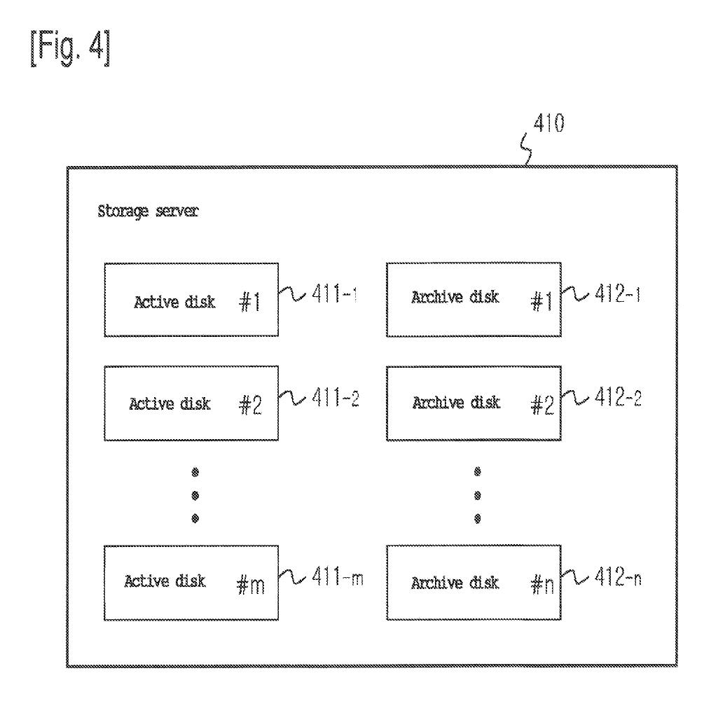

Although it is not shown in the figure, in the distributed storage system according to another embodiment of the present invention, the storage servers for storing files in a distributed manner may not be divided into active servers and archive servers, and each of the storage servers may be implemented to include an active disk and/or an archive disk. FIG. 4 shows the structure of a storage server 410 including a plurality of active disks 411 and archive disks 412. In this case, the file management apparatus according to the present invention relocates and stores the original file and some or all of copy files of a file selected as an archive file from the active disk to the archive disk, and this can be implemented to relocate the files from an active disk to an archive disk within a storage server or from an active disk of a first storage server to an archive disk of a second storage server.

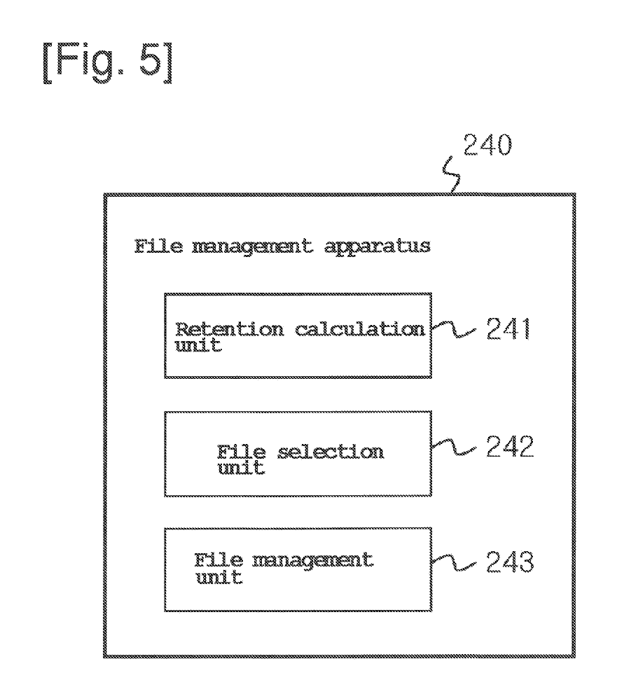

In relation to this, FIG. 5 shows the detailed configuration of a file management apparatus according to an embodiment of the present invention. As shown in the figure, the file management apparatus 240 according to an embodiment of the present invention includes a retention time calculation unit 241, a file selection unit 242 and a file management unit 243, and particularly, the file management apparatus 240 can be advantageously applied to the distributed storage system shown in FIG. 2.

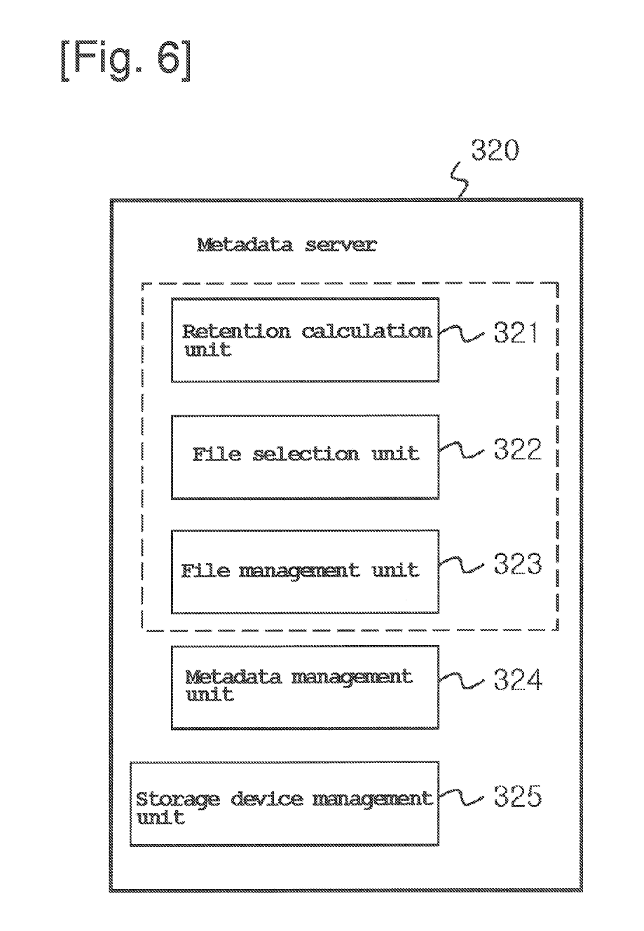

In addition, FIG. 6 is a view showing the detailed configuration of a file management apparatus 320 according to another embodiment of the present invention. As shown in the figure, the file management apparatus 320 according to another embodiment of the present invention includes a retention time calculation unit 321, a file selection unit 322, a file management unit 323, a metadata management unit 324 and a storage device management unit 325, and particularly, the file management apparatus 320 can be advantageously applied to the distributed storage system shown in shown in FIG. 3.

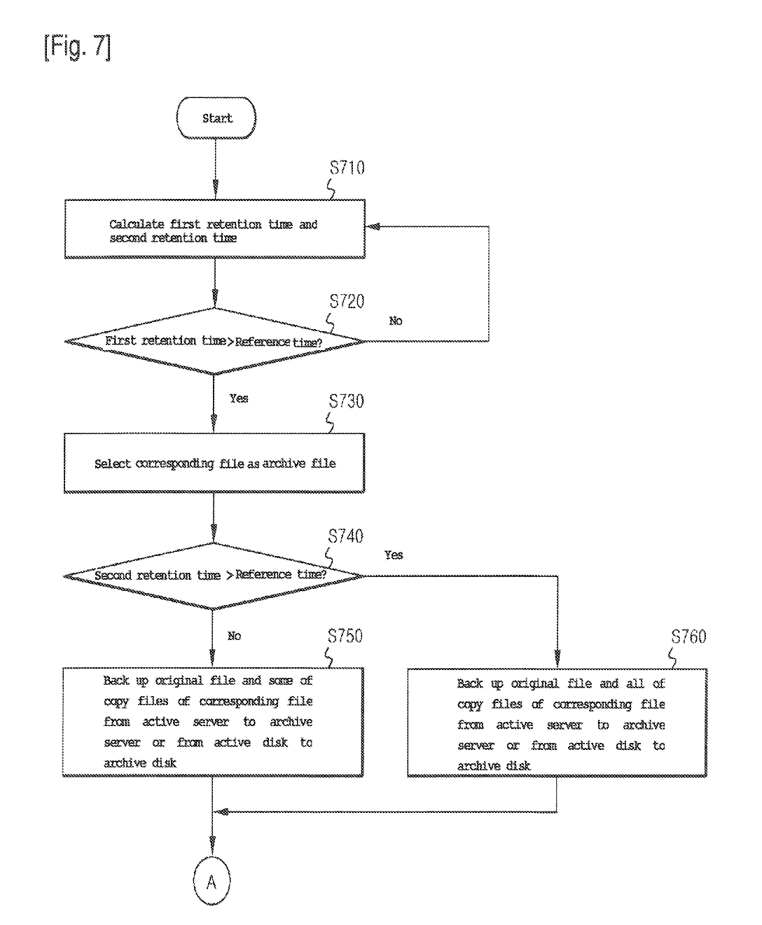

Meanwhile, FIG. 7 shows a flowchart illustrating a file management method in a distributed storage system according to an embodiment of the present invention. Specifically, a first and a second file retention times are calculated based on the current time, file creation time, file modification time and recent file inquiry time, and an archive file is selected based on the first and second file retention times, and then the original file and some or all of copy files of the file are backed up from an active server to an archive server or from an active disk to an archive disk.

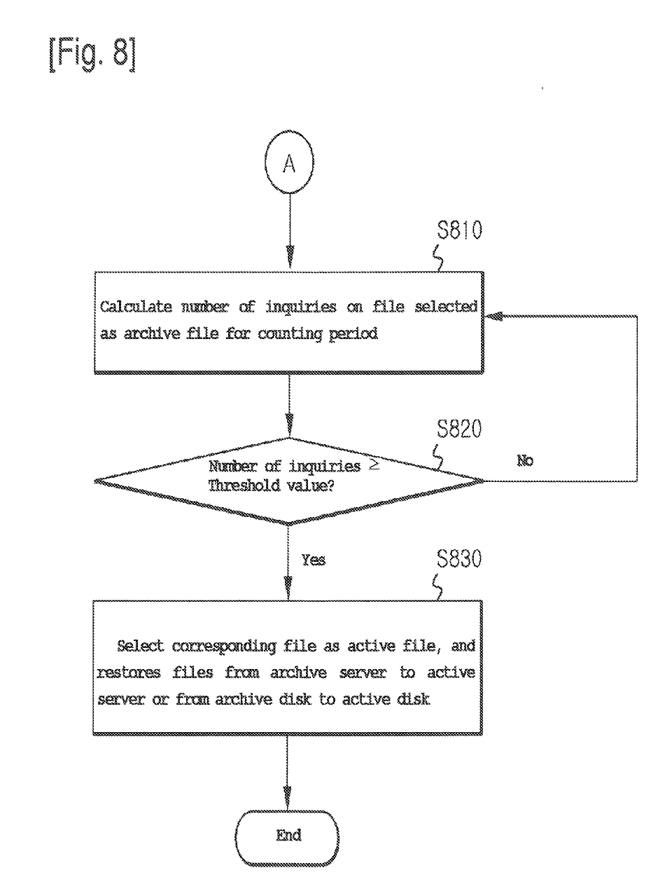

Then, FIG. 8 is a flowchart illustrating a file management method in a distributed storage system according to another embodiment of the present invention. Specifically, it shows that if the number of inquiries on a file selected as an archive file counted in a counting period is larger than a predetermined threshold value, the file is restored from an archive sever to an active server or from an archive disk to an active disk.

Hereinafter, a file management apparatus and method in a distributed storage system according to the present invention will be described in detail with reference to FIGS. 2 to 9. For reference, practically the same or similar configurations and functions will be described equally without discrimination although embodiments of the present invention are slightly different.

First, referring to FIGS. 5 and 6, the retention time calculation unit 241 and 321 of the file management apparatus according to the present invention calculates a retention time of a file based on the current time, file creation time, file modification time and recent file inquiry time (refer to S710 of FIG. 7).

For example, the retention time calculation unit 241 and 321 may be implemented to calculate the first retention time by subtracting the file creation time or the file modification time from the current time in order to consider the time point when the files is created or modified and to calculate the second retention time by subtracting the recent file inquiry time from the current time in order to consider the time point when the information is finally inquired.

For reference, in the present invention, the file creation time, the file modification time and the recent file inquiry time subtracted from the current time in order to calculate the file retention time is referred to as a data time, and this can be implemented to be set by a user or a manager. In this case, the file retention time can be defined as shown in mathematical expression 1.

File retention time=Current time−Data time [Mathematical expression 1]

In addition, in the file management apparatus according to the present invention, the file selection unit 242 and 322 selects an active file and an archive file by comparing the file retention time calculated as described above with a predetermined reference time.

Specifically, the file selection unit 242 and 322 compares the first retention time obtained by subtracting the file creation time or the recent modification time from the current time with the reference time (refer to S720 of FIG. 7) and selects a corresponding file as an archive file if the first retention time is larger than the reference time (refer to S730 of FIG. 7).

In addition, the file selection unit 242 and 322 may compare the second retention time obtained by subtracting the recent file inquiry time from the current time with the reference time (refer to S740 of FIG. 7) and transmits a result of the comparison to the file management unit 243 and 323.

Then, the file management unit 243 and 323 of the file management apparatus according to the present invention backs up the original file and some or all of copy files of the file selected as an archive file from an active server to an archive server or from an active disk to an archive disk depending on a result of the selection of the file selection unit 242 and 322.

In this case, the file management unit 243 and 323 backs up the original file and some of the copy files of the file selected as an archive file from an active server to an archive server or from an active disk to an archive disk if the first retention time is larger than the reference time and the second retention time is smaller than the reference time (a first stage backup) (refer to S750 of FIG. 7) and backs up the original file and all of the copy files of the file selected as an archive file from an active server to an archive server or from an active disk to an archive disk if the first retention time and the second retention are larger than the reference time (a second stage backup) (refer to S750 of FIG. 7). That is, according to a preferred embodiment of the present invention, a two stage backup is performed considering the recent file inquiry time, as well as the file creation time and the file modification time, in which some of the files (the original and copy files) of a file selected as an archive file are backed up first and then the other files are backed up at a later time.

Meanwhile, the multi stage backup described above may be performed by the setting of the user (manager) or automatically performed, and in this case, the number of backup files (N) may be set, for example, as shown in mathematical expression 2 in the first stage backup which backs up some of the files.

N=Nₜₒₜₐₗ*(offset_time_{—}1/tₘₐₓ) [Mathematical expression 2]

Here, Nₜₒₜₐₗ denotes the total number of the original and copy files, offset_time_{—}1 denotes a value obtained by subtracting the reference time from the first retention time, and tₘₐₓ denotes a value of offset_time_{—}1 when a value obtained by subtracting the reference time from the second retention time is 0.

Then, if the present invention is implemented as described above, the retention time calculation unit 241 and 321 can be implemented to calculate an offset time offset_time in advance as shown in mathematical expression 3, and the file selection unit 242 and 322 can be implemented to select an active file and an archive file by determining whether the offset time is positive (+) or negative (−).

Offset time=(Current time−Data time)−Reference time [Mathematical expression 3]

The reason why the backup is performed in two stages as described above in the present invention is as follows. The first case (refer to S750 of FIG. 7) is considered as a state before the backup is completely finished. In this state, the possibility of a corresponding file to be used again exists to some extent, and thus some of the files (the original and copy files) are remained in an active server having a good performance to deal with queries requested by clients.

In addition, according to a preferred embodiment of the present invention, the file management unit 243 and 323 can be implemented to back up files by the unit of file or chunk when the original file and some or all of the copy files of a file selected as an archive file are backed up.

Meanwhile, although an archive file is selected and the original file and some or all of the copy files of a corresponding file are backed up (relocated) to an archive server or an archive disk, management on these files is continued. If the number of inquiries on this file increases again, some or all of the backed files (the original and copy files) are restored to an active server or an active disk.

Specifically, the file selection unit 242 and 322 continuously observes the number of inquiries on this file selected as an archive file for a certain counting period (refer to S810 of FIG. 8) and compares the number of inquiries counted in the counting period with a predetermined threshold value (refer to S820 of FIG. 8). If the counted number of inquiries is larger than the threshold value, the file is selected as an active file and restored from an archive server to an active server or from an archive disk to an active disk (refer to S830 of FIG. 8). In addition, if a file selected as an archive file is modified, the file selection unit 242 and 322 may select the file as an active file and restore the file from an archive server to an active server or from an archive disk to an active disk.

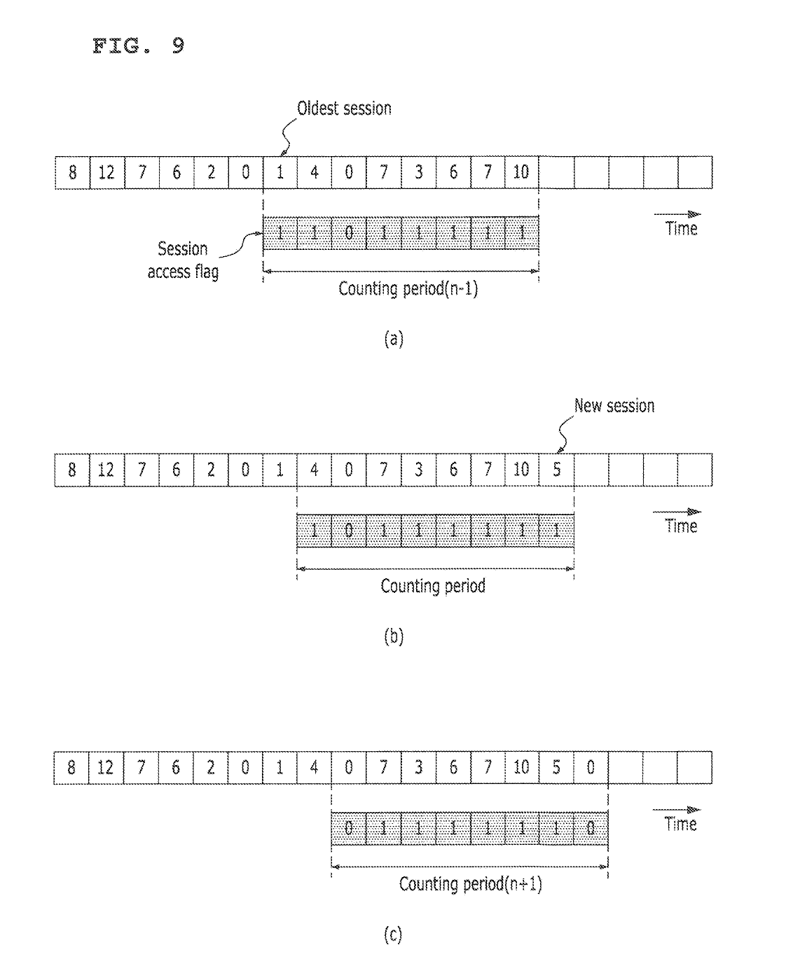

For reference, FIG. 9 is a view showing an example of a method of counting the number of inquiries using a session access flag according to the present invention. The method of counting the number of inquiries shown in FIG. 9 sets a length corresponding to an exponentiation of two as a counting period and effectively reduces usage of memory and the amount of operation using the number of inquiries in all sessions corresponding to the counting period, the number of inquiries in a new session and a session access flag.

That is, in the case of FIG. 9(b), the number of inquiries in the current (n-th) counting period is calculated by subtracting the number of inquiries corresponding to the oldest session from the number of inquiries [38] counted in the previous (n−1-th) counting period and then adding the number of inquiries [5] counted in a new session. In this case, since the number of inquiries corresponding to the oldest session does not remain in memory, it is obtained by dividing the total number of inquiries [38] counted in the previous counting period by the number of sessions [7] having a session access flag of 1 among the sessions corresponding to the previous counting period and then multiplying a value of the session access flag [1] of the oldest session. Accordingly, the number of inquiries corresponding to the oldest session becomes about 5.43[=(38/7)*1], and this is an average of the number of inquiries in the sessions whose session access flag is 1 (i.e., sessions where inquiry is requested at least once). For further detailed descriptions related to this, “Apparatus and method for managing a file in a distributed storage system”, Korean Patent Application No. 10-2009-0105661 applied on Nov. 3, 2009, can be referred, and the application of the patent is included and combined in this specification.

Finally, the metadata management unit 324 and the storage device management unit 325 of FIG. 6 are constitutional components that can be further included if the file management apparatus according to the present invention is implemented in a metadata server.

Describing in short, the metadata management unit 324 creates and manages metadata of the files stored in a plurality of storage servers (active servers and archive servers) in a distributed manner, and the storage device management unit 325 manages information on performance and capacity of the plurality of storage servers. Accordingly, the file management unit 323 may further efficiently manage the files in association with the metadata management unit 324 and/or the storage device management unit 325.

Meanwhile, the method of managing a file in a distributed storage system according to the present invention may be embodied through a computer readable recording medium containing program commands for performing the operations implemented in a variety of computers. The computer readable medium may include program commands, data files, data structures and the like in a single or combined form. The recording medium may be a medium that is specially designed and configured for the present invention or a medium that is publicized and available for those skilled in the computer software art. Examples of the computer readable medium include magnetic media such as a hard disk, a floppy disk and a magnetic tape, optical media such as a CD-ROM and a DVD, magneto-optical media such as a floptical disk, and hardware devices specially configured to store and execute the program commands, such as ROM, RAM and flash memory. Examples of the program commands include high-level language codes that can be executed by a computer using an interpreter or the like, as well as machine codes such as those generated by a compiler.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A file management apparatus for managing a file in a distributed storage system, the apparatus comprising:
a retention time calculation unit for calculating a retention time of the file based on at least one of a current time, a file creation time, a file modification time and a recent file inquiry time;
a file selection unit for selecting the file as an archive file if the file retention time is larger than a predetermined reference time; and
a file management unit for relocating an original file and some or all of copy files of the file selected as an archive file from an active server to an archive server or from an active disk to an archive disk.

2. The apparatus according to claim 1, wherein the retention time calculation unit calculates a first retention time by subtracting the file creation time or the file modification time from the current time and a second retention time by subtracting the recent file inquiry time from the current time, and the file management unit relocates the original file and some of the copy files of the file selected as an archive file from the active server to the archive server or from the active disk to the archive disk if the first retention time is larger than the reference time and the second retention time is smaller than the reference time.

3. The apparatus according to claim 2, wherein the original file and some of the copy files (N) relocated to the archive server or the archive disk are determined by mathematical expression N=Nₜₒₜₐₗ*(offset_time_{—}1/tₘₐₓ), wherein, Nₜₒₜₐₗ denotes a total number of the original and copy files, offset_time_{—}1 denotes a value obtained by subtracting the reference time from the first retention time, and tₘₐₓ denotes a value of offset_time_{—}1 when a value obtained by subtracting the reference time from the second retention time is 0.

4. The apparatus according to claim 1, wherein a file state management unit calculates a first retention time by subtracting the file creation time or the file modification time from the current time and a second retention time by subtracting the recent file inquiry time from the current time, and the file management unit relocates the original file and all of the copy files of the file selected as an archive file from the active server to the archive server or from the active disk to the archive disk if the first retention time and the second retention time are larger than the reference time.

5. The apparatus according to claim 1, wherein if the number of inquiries on the file selected as an archive file counted in a counting period is larger than a predetermined threshold value, the file selection unit selects the file as an active file, and the file management unit restores the original file and some or all of the copy files of the file selected as an active file from the archive sever to the active server or from the archive disk to the active disk.

6. The apparatus according to claim 1, wherein if the file selected as an archive file is modified, the file selection unit selects the file as an active file, and the file management unit restores the original file and some or all of the copy files of the file selected as an active file from the archive sever to the active server or from the archive disk to the active disk.

7. The apparatus according to claim 1, wherein the file management unit relocates the original file and some or all of the copy files of the file selected as an archive file by a unit of file or chunk.

8. The apparatus according to claim 1, wherein the active server has a relatively good performance compared to the archive server.

9. The apparatus according to claim 1, further comprising a metadata management unit for managing metadata of a file requested by a client.

10. The apparatus according to claim 1, further comprising a storage server management unit for managing information on performance and capacity of a plurality of storage devices.

11. A distributed storage system comprising:
a plurality of storage servers including an active server and an archive server for storing a file in a distributed manner; and
a metadata server for managing metadata of the file, wherein
the metadata server calculates a retention time of the file based on at least one of a current time, a file creation time, a file modification time and a recent file inquiry time, and relocates an original file and some or all of copy files of the corresponding fire from the active server to the archive server if the retention time of the file is larger than a predetermined reference time.

12. The system according to claim 11, wherein if the number of inquiries on a file selected as an archive file counted in a counting period is larger than a predetermined threshold value, the metadata server restores the original file and some or all of the copy files of the corresponding file from the archive sever to the active server.

13. The system according to claim 11, wherein the metadata server calculates a first retention time by subtracting the file creation time or the file, modification time from the current time and a second retention time by subtracting the recent file inquiry time from the current time, and relocates the original file and some of the copy files of the file selected as an archive file from the active server to the archive server if the first retention time is larger than the reference time and the second retention time is smaller than the reference time.

14. The system according to claim 13, wherein the original file and some of the copy files (N) relocated to the archive server are determined by mathematical expression N=Nₜₒₜₐₗ*(offset_time_{—}1/tₘₐₓ), wherein, Nₜₒₜₐₗ denotes a total number of the original and copy files, offset_time_{—}1 denotes a value obtained by subtracting the reference time from the first retention time, and tₘₐₓ denotes a value of offset_time_{—}1 when a value obtained by subtracting the reference time from the second retention time is 0.

15. The system according to claim 11, wherein the metadata server calculates a first retention time by subtracting the file creation time or the file modification time from the current time and a second retention time by subtracting the recent file inquiry time from the current time, and relocates the original file and all of the copy files of the file selected as an archive file from the active server to the archive server if the first retention time and the second retention time are larger than the reference time.

16. A distributed storage system comprising:
at least a storage server including an active disk and an archive disk for storing a file in a distributed manner; and
a metadata server for managing metadata of the file, wherein
the metadata server calculates a retention time of the file based on at least one of a current time, a file creation time, a file modification time and a recent file inquiry time, and relocates an original file and some or all of copy files of the corresponding file from the active disk to the archive disk if the retention time of the file is larger than a predetermined reference time.

17. The system according to claim 16, wherein if the number of inquiries on a file selected as an archive file counted in a counting period is larger than a predetermined threshold value, the metadata server restores the original file and some or all of the copy files of the corresponding file from the archive disk to the active disk.

18. The system according to claim 16, wherein the metadata server calculates a first retention time by subtracting the file creation time or the file modification time from the current time and a second retention time by subtracting the recent file inquiry time from the current time, and relocates the original file and some of the copy files of the file selected as an archive file from the active disk to the archive disk if the first retention time is larger than the reference time and the second retention time is smaller than the reference time.

19. The system according to claim 18, wherein the original file and some of the copy files (N) relocated to the archive disk are determined by mathematical expression N=Nₜₒₜₐₗ*(offset_time_{—}1/tₘₐₓ), wherein, Nₜₒₜₐₗ denotes a total number of the original and copy files, offset_time_{—}1 denotes a value obtained by subtracting the reference time from the first retention time, and tₘₐₓ denotes a value of offset_time_{—}1 when a value obtained by subtracting the reference time from the second retention time is 0.

20. The system according to claim 16, wherein the metadata server calculates a first retention time by subtracting the file creation time or the file modification time from the current time and a second retention time by subtracting the recent file inquiry time from the current time, and relocates the original file and all of the copy files of the file selected as an archive file from the active disk to the archive disk if the first retention time and the second retention time are larger than the reference time.

21. A file management method for managing a file in a distributed storage system, the method comprising the steps of:
calculating a retention time of the file based on at least one of a current time, a file creation time, a file modification time and a recent file inquiry time;
selecting the file as an archive file if the retention time of the file is larger than a predetermined reference time; and
relocating an original file and some or all of copy files of the file selected as an archive file from an active server to an archive server or from an active disk to an archive disk.

22. The method according to claim 21, wherein the step of calculating a retention time includes the step of calculating a first retention time by subtracting the file creation time or the file modification time from the current time and a second retention time by subtracting the recent file inquiry time from the current time, and the relocating step relocates the original file and some of the copy files of the file selected as an archive file from the active server to the archive server or from the active disk to the archive disk if the first retention time is larger than the reference time and the second retention time is smaller than the reference time.

23. The method according to claim 22, wherein the original file and some of the copy files (N) relocated to the archive server or the archive disk are determined by mathematical expression N=Nₜₒₜₐₗ*(offset_time_{—}1/tₘₐₓ), wherein, Nₜₒₜₐₗ denotes a total number of the original and copy files, offset_time_{—}1 denotes a value obtained by subtracting the reference time from the first retention time, and tₘₐₓ denotes a value of offset_time_{—}1 when a value obtained by subtracting the reference time from the second retention time is 0.

24. The method according to claim 21, wherein the step of calculating a retention time includes the step of calculating a first retention time by subtracting the file creation time or the file modification time from the current time and a second retention time by subtracting the recent file inquiry time from the current time, and the relocating step relocates the original file and all of the copy files of the file selected as an archive file from the active server to the archive server or from the active disk to the archive disk if the first retention time and the second retention time are larger than the reference time.

25. The method according to claim 21, wherein the relocating step relocates the original file and some or all of the copy files of the file selected as an archive file by a unit of file or chunk.

26. The method according to claim 21, further comprising the steps of:
if the number of inquiries on the file selected as an archive file counted in a counting period is larger than a predetermined threshold value,
selecting the file as an active file; and
restoring the original file and some or all of the copy files of the file selected as an active file from the archive sever to the active server or from the archive disk to the active disk.

27. A computer readable recording medium for recording a program which performs the file management method according to claim 21.
